(19) United States
(12) Patent Application Publication
(10) Pub. No.: US 2025/0299353 A1
(43) Pub. Date: Sep. 25, 2025

(54) ELECTRONIC DEVICE

(71) Applicant: Japan Display Inc., Tokyo (JP)

(72) Inventors: Yoshiro AOKI, Tokyo (JP); Hirondo NAKATOGAWA, Tokyo (JP); Hitoshi TANAKA, Tokyo (JP)

(73) Assignee: Japan Display Inc., Tokyo (JP)

(21) Appl. No.: 19/088,902

(22) Filed: Mar. 24, 2025

(30) Foreign Application Priority Data
Mar. 25, 2024 (JP) 2024-048060

(51) Int. Cl. G06T 7/571; H04N 23/67

(52) U.S. Cl. CPC G06T 7/571; H04N 23/676

(57) ABSTRACT

According to one embodiment, an electronic device includes a processor configured to cause a liquid crystal panel to alternately display a first pattern and a second pattern, cause an image-capturing element to alternately capture first and second images of an object overlapped with the first and second patterns, after the second image being captured, measure a distance of the object based on the second image and the first image captured prior to the second image, and after the first image being captured, measure a distance of the object based on the first image and the second image captured prior to the first image.

### CROSS-REFERENCE TO RELATED APPLICATION

This application is based upon and claims the benefit of priority from Japanese Patent Application No. 2024-048060, filed Mar. 25, 2024, the entire contents of which are incorporated herein by reference.

### FIELD

Embodiments described herein relate generally to an electronic device for distance measurement.

### BACKGROUND

A technique of measuring a distance of each portion of an image using blur has been known. A filter having a certain pattern is attached to a lens of a camera. An image of an object overlapped with the certain pattern is captured. Deviation of an object from a focused state blurs an image. The degree of blur depends on the degree of deviation of the object from the focused state. When an object is overlapped with the certain pattern, a shape of blur is different between cases where an object is in front of a focus position and cases where the object is behind the focus position. Thus, a distance to each portion of the object is measured based on the degree and the shape of blur in each pixel. The certain pattern is called a coded pattern.

Distances may be measured from an image of an object overlapped with a coded pattern. An accurate distance is measured from at least two images of objects overlapped with two different coded patterns. However, in videos, this method makes a rate for distance measurement the half of a rate for image-capturing.

### BRIEF DESCRIPTION OF THE DRAWINGS

FIG. 1A shows an example of a camera controlled by an electronic device according to the first embodiment.

FIG. 1B shows an example of the camera controlled by the electronic device according to the first embodiment.

FIG. 2 is an exploded perspective view showing an example of the camera controlled by the electronic device according to the first embodiment.

FIG. 3 is a block diagram illustrating an example of the electronic device according to the first embodiment.

FIG. 4A is a diagram showing an example of a coded pattern used in the electronic device according to the first embodiment.

FIG. 4B is a diagram showing an example of a coded pattern used in the electronic device according to the first embodiment.

FIG. 5 is a flowchart showing an example of a camera control by the electronic device according to the first embodiment.

FIG. 6 is a flowchart showing an example of a distance measurement by the electronic device according to the first embodiment.

FIG. 7 is a sequence chart showing an example of a flow of processes executed by the electronic device according to the first embodiment.

FIG. 8 is a sequence chart showing another example of a flow of processes executed by the

FIG. 9 is a side view showing an example of a camera according to the second embodiment.

FIG. 10 is an exploded perspective view showing an example of a camera according to the second embodiment.

FIG. 11 is a side view showing an example of a camera according to the third embodiment.

FIG. 12 is a side view showing an example of a camera according to the fourth embodiment.

FIG. 13 is a side view showing an example of a camera according to the fifth embodiment.

FIG. 14 is a side view showing an example of a camera according to the sixth embodiment.

FIG. 15 is a side view showing an example of a camera according to the seventh embodiment.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, an electronic device includes a liquid crystal panel, an image-capturing element configured to capture an image of an object via the liquid crystal panel, and a processor configured to control the liquid crystal panel and the image-capturing element. The processor is configured to cause the liquid crystal panel to alternately display a first pattern and a second pattern, cause the image-capturing element to alternately capture a first image of an object overlapped with the first pattern and a second image of the object overlapped with the second pattern, after the second image being captured, measure a distance of the object based on the second image and the first image captured prior to the second image, and after the first image being captured, measure a distance of the object based on the first image and the second image captured prior to the first image.

### First Embodiment

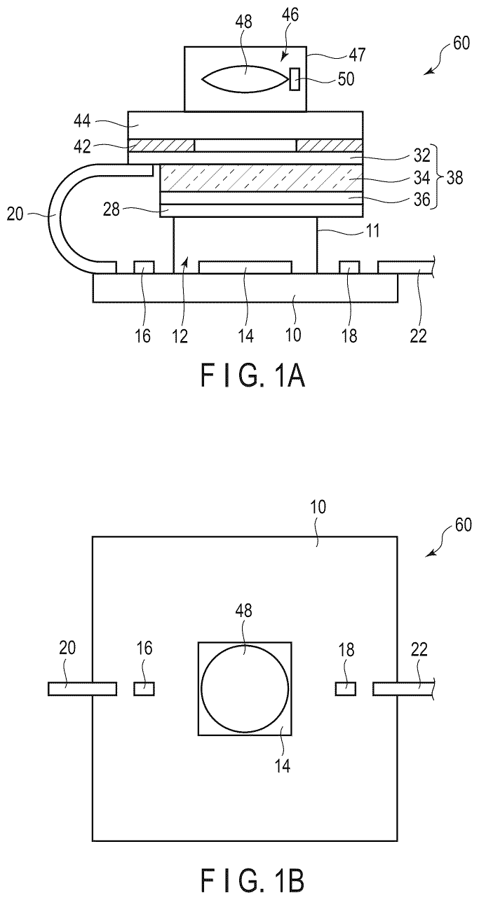

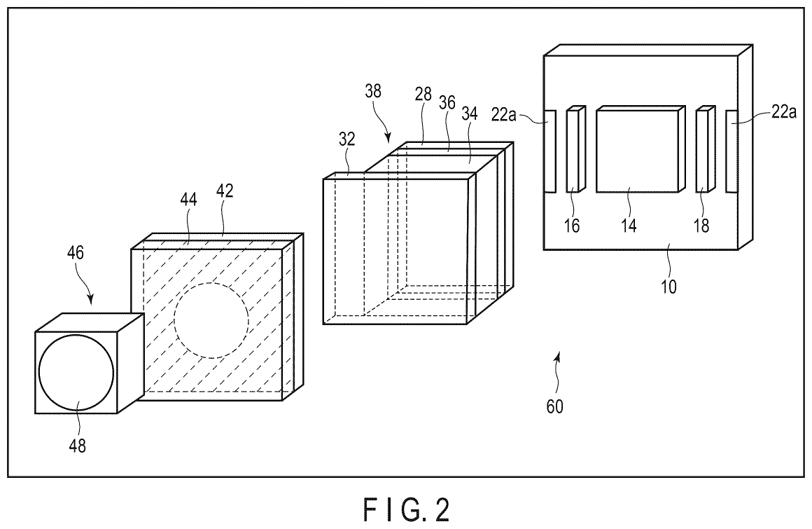

FIG. 1A, FIG. 1B, and FIG. 2 show an example of a camera 60 controlled by an electronic device according to the first embodiment. FIG. 1A is a side view showing an example of a structure of the camera 60. FIG. 1B is a top view showing an example of the structure of the camera 60.

The camera 60 includes a camera substrate 10. A position at which the camera substrate 10 is provided in the camera 60 is called a lower portion of the camera 60. Components of the camera 60 are provided on a top surface side of the camera substrate 10. An example of the components includes a camera module 12, a liquid crystal driver 16, or a camera driver 18. Though not illustrated in figures, circuit components such as a resistor and an inductance are provided on the camera substrate 10. The camera substrate 10 includes signal lines for electrically connecting components of the camera 60 with circuit components one another.

The camera module 12 includes a camera casing 11 and an image-capturing element 14 provided inside the camera casing 11. The image-capturing element 14 captures color images. An example of the image-capturing element 14 includes a CCD sensor or CMOS sensor. In the present specification, of sides of the camera substrate 10, the side on which the camera module 12 is provided is called the top side of the camera substrate 10.

An infrared (IR) filter 28, a liquid crystal panel 38, a light-shielding plate 42, a cover board 44, and a lens module 46 are arranged in this order in the top side of the camera module 12. The IR filter 28 is touched to or substantially touched to the camera module 12. The liquid crystal panel 38 is touched to or substantially touched to the IR filter 28. The light-shielding panel 42 id touched to or substantially touched to the liquid crystal panel 38. The cover board 44 is touched to or substantially touched to the light-shielding plate 42. The lens module 46 is touched to or substantially touched to the cover board 44.

An end of each of flexible printed films 20 and 22 is electrically connected to the camera substrate 10. The liquid crystal driver 16 is a drive circuit component. The liquid crystal driver 16 drives the liquid crystal panel 38 to display a certain pattern. The liquid crystal driver 16 is an integrated circuit and formed as an IC chip. The liquid crystal driver 16 supplies an LCD drive signal to the liquid crystal panel 38 via the flexible printed film 20. The LCD drive signal includes a voltage signal and a control signal.

The liquid crystal driver 16 supplies the LCD drive signal to the liquid crystal panel 38. The liquid crystal panel 38 displays a coded pattern as the certain pattern. The image-capturing element 14 captures an image of an object overlapped with the coded pattern. The distance to each portion of an object can be measured based on this image.

In addition to capturing an image for distance measurement, the camera 60 can function as a general camera. In that case, the liquid crystal driver 16 supplies the LCD drive signal for displaying the diaphragm pattern to the liquid crystal panel 38. The liquid crystal panel 38 displays the diaphragm pattern. The diaphragm pattern includes a center portion transmitting light and a periphery portion shielding light. The control signal controls the diameter of the center portion. The diameter of the center portion is based on a brightness of surroundings of the camera 60. An optical sensor (not shown) measures the brightness of surroundings. As the surroundings of the camera 60 become brighter, the diameter of the center portion decreases. As the surroundings of the camera become darker, the diameter of the center portion increases. The diameter of the center portion (i.e., a diaphragm value) is also based on a depth of field of the camera 60. As the diameter of the diaphragm decreases (that is, as a diaphragm value increases), the depth of field increases.

The camera driver 18 is a drive circuit component. The camera driver 18 supplies a camera signal for driving the camera 60 to the image-capturing element 14. The image-capturing element 14 captures an image. The camera driver 18 is an integrated circuit and formed as an IC chip. The camera driver 18 supplies the camera signal to the liquid crystal driver 16 via the camera substrate 10. In association with driving of the liquid crystal panel 38, the camera driver 18 drives the image-capturing element 14 captures an image. The camera driver 18 may control a driving timing of the liquid crystal driver 16 to coincide with the driving timing of the image-capturing element 14. Capturing an image by the image-capturing element 14 may be synchronized with displaying an image (the coded pattern or the diaphragm pattern) by the liquid crystal panel 38.

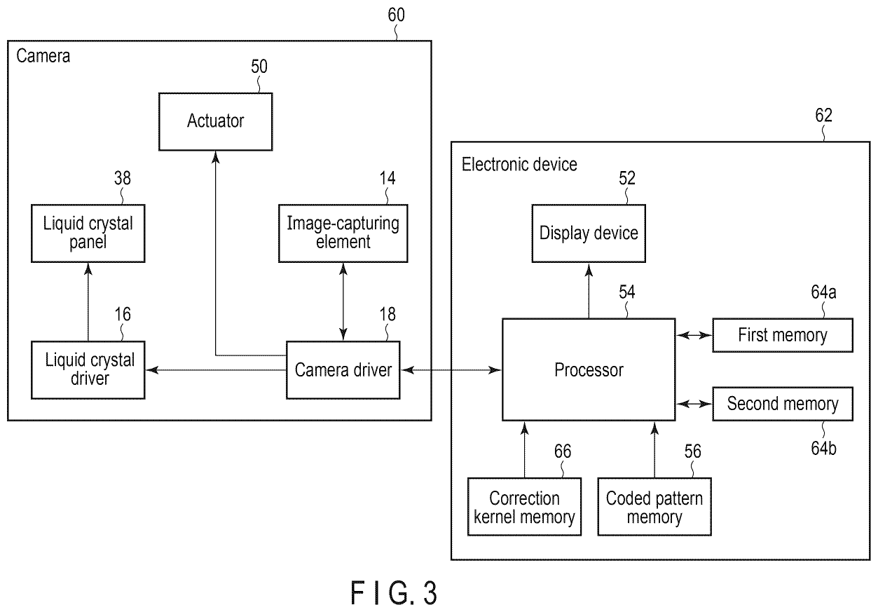

The image signal output from the image-capturing element 14 is supplied to the camera driver 18 via the camera substrate 10. The camera driver 18 supplies the image signal to an external electronic device via the flexible printed film 22. The external electronic device includes a processor configured to process image signal. Processing image signal involves distance measurement. The processor supplies the LCD drive signal corresponding to the diaphragm pattern or the coded pattern to the liquid crystal driver 16 via the flexible printed film 22. The processor also supplies the camera signal to the camera driver 18 via the flexible printed film 22. The liquid crystal driver 16 supplies the LCD drive signal to the liquid crystal panel 38 via the flexible printed film 20. The LCD drive signal that have entered the camera substrate 10 from the flexible printed film 20 may be transmitted to the liquid crystal driver 16 via the camera driver 18 or may be supplied to the liquid crystal driver 16 via signal lines formed on the camera substrate 10. Details of the electronic device will be described with reference to FIG. 3.

The IR filter 28 transmits light other than an infrared light. The IR filter 28 prevents infrared light from being made incident on the image-capturing element 14.

The liquid crystal panel 38 includes an array substrate 32, a liquid crystal layer 34, and a counter-substrate 36. The liquid crystal layer 34 is provided between the counter-substrate 36 and the array substrate 32. The counter-substrate 36 is provided below the liquid crystal layer 34. A black matrix, an overcoat layer, an alignment film, and the like are formed on the counter-substrate 36. The liquid crystal panel 38 is provided to control transmission of visible light or control a pattern of a coded aperture. Thus, the counter-substrate 36 includes no color filter. The counter-substrate 36 may include a multilayer substrate. The array substrate 32 is provided on the liquid crystal layer 34. A common electrode, a pixel electrode, an alignment film, an active device, and the like are formed on the array substrate 32. An example of the active device includes a thin-film transistor (TFT). The array substrate 32 may include a multilayer substrate. The present embodiment adopts an active matrix liquid crystal panel as the liquid crystal panel 38. Alternatively, passive matrix liquid crystal panels may be adopted as the liquid crystal panel 38. For example, TN liquid crystal panel, which features a high response speed, may be adopted as the passive matrix liquid crystal panel.

The flexible printed film 20 is electrically connected to either the array substrate 32 or the counter-substrate 36. For example, the flexible printed film 20 is connected to a surface of the array substrate 32 facing the liquid crystal layer 34. This configuration can eliminate a gap between the light-shielding plate 42 and the array substrate 32. The array substrate 32 requires a contact area for the flexible printed film 20. Thus, the array substrate 32 is greater in size than the counter-substrate 36.

The flexible printed film 20 may be connected to a surface of the array substrate 32 facing the light-shielding plate 42.

Further, the flexible printed film 20 may be connected to the surface of the counter-substrate 36. In this case, the counter-substrate 36 requires a contact area for the flexible printed film 20. Thus, the counter-substrate 36 is greater in size than the array substrate 32.

The liquid crystal driver 16 generates a first voltage signal, second voltage signal, and control signal. The liquid crystal driver 16 supplies the first voltage signal to pixel electrodes of the liquid crystal panel 38 via the active devices. The liquid crystal driver 16 supplies the second voltage signal to common electrodes of the liquid crystal panel 38. The liquid crystal driver 16 supplies the control signal to control terminals of the active devices of the liquid crystal panel 38. The control signal corresponds to an image to be displayed (a coded pattern or a diaphragm pattern). The active device switches between a conductive state and a non-conductive state according to a pixel of an image to be displayed. The voltage applied between the pixel electrode and the common electrode vary for pixels. The transmittance of the liquid crystal layer 34 varies for pixels. This configuration allows the liquid crystal panel 38 to display an image.

The light-shielding plate 42 is provided on the array substrate 32. The light-shielding plate 42 includes an aperture in its center portion. Light made incident on the light-shielding plate 42 via a lens 48 passes through the aperture and then is made incident on the liquid crystal panel 38. A portion of the light-shielding plate 42 other than the aperture is a light-shielding portion, which does not transmit light. The light-shielding plate 42 controls entrance of unnecessary external light from the lens 48 toward the image-capturing element 14. Instead of the light-shielding plate 42, the same pattern of the light-shielding plate 42 may be printed on the array substrate 32 or the counter-substrate 36. The array substrate 32 or the counter-substrate 36 may function as the light-shielding plate 42.

The cover board 44 is provided on the light-shielding plate 42. The cover board 44 is a planar element for protecting components of the camera 60 other than the lens module 46, in other words, the liquid crystal panel 38 and the camera module 12. Instead of providing the light-shielding plate 42, the same pattern as the light-shielding portion of the light-shielding plate 42 may be printed on the cover board 44. Thus, the cover board 44 may further function as the light-shielding plate 42.

The lens module 46 is provided on the cover board 44. The lens module 46 includes a lens casing 47, a lens 48, and an actuator 50. The lens 47 and actuator 50 are arranged in the lens casing 47. The lens 48 may be formed of a single lens or multiple lenses. The actuator 50 is electrically connected to the camera driver 18 via a signal line (not shown). The camera driver 18 determines a focused state based on an output signal from the image-capturing element 14 and drives the actuator 50 to shift the lens 48 in the optical axis direction such that the lens 48 is in the focused state. The camera driver 18 determines the focused state based on, for example, a phase difference between the output signals from two different pixels.

FIG. 2 is an exploded perspective view showing an example of the camera 60 controlled by the electronic device according to the first embodiment. FIG. 2 omits the illustration of the flexible printed films 20 and 22 but shows contacts 20a and 22a of the camera substrate 10. The flexible printed films 20 and 22 are respectively connected to the contacts 20a and 22a.

FIG. 3 is a block diagram illustrating an example of an electrical configuration of an electronic device 62 according to the first embodiment. The electronic device 62 includes a display device 52, a processor 54, a coded pattern memory 56, a first memory 64a, a second memory 64b, and a correction kernel memory 66. The first memory 64a and the second memory 64b may be formed of independent different memories or different storage areas of one memory. The camera 60 is connected to the processor 54.

The processor 54 is connected to the coded pattern memory 56, the first memory 64a, the second memory 64b, the correction kernel memory 66, and the display device 52. The coded pattern memory 56 stores coded pattern data indicative of a coded pattern to be overlapped on an image of an object. When an object deviates from the focused state, the coded pattern in the image blurs according to the deviation. The correction kernel memory 66 stores blur correction kernels for correcting blur in an image. A suitable blur correction kernel depends on the distance to an object. The correction kernel memory 66 stores blur correction kernels that correspond to many distances. The coded pattern memory 56 and the correction kernel memory 66 may be formed of a read-only memory. In this case, the coded pattern memory 56 and the correction kernel memory 66 may be formed of independent memories or different storage areas of one memory. Further, when the coded pattern memory 56 and the correction kernel memory 66 are not formed of read-only memories, the coded pattern memory 56, the correction kernel memory 66, the first memory 64a, and the second memory 64b may be formed of different storage areas of one memory. Further, the coded pattern memory 56, the correction kernel memory 66, the first memory 64a, and the second memory 64b may be formed as external memories of the processor 54 or as internal memories of the processor 54.

The processor 54 supplies the LCD drive signal corresponding to a coded pattern to the camera driver 18. The camera driver 18 synchronizes driving of the image-capturing element 14 and controls driving timing of the liquid crystal driver 16.

An image signal output from the image-capturing element 14 is input to the processor 54 via the camera driver 18. The liquid crystal panel 38 displays a coded pattern. The image-capturing element 14 captures an image of an object overlapped with the coded pattern. The image-capturing element 14 transmits image signal to the processor 54. The processor 54 writes image signals of two images respectively to the first memory 64a and the second memory 64b.

The processor 54 performs convolution for an image signal of each pixel and the blur correction kernels. The processor 54 detects a blur correction kernel which provides the result of convolution corresponding to the minimum blur. The processor 54 determines a distance corresponding to the blur correction kernel as a measurement result of a distance to an object. An image of an object overlapped with one coded pattern may provide multiple measurement results. Using at least two images of an object overlapped with two different coded patterns provides one blur correction kernel which provides the result of convolution corresponding to the minimum blur. The embodiments measure distances based on two images of an object overlapped with two different coded patterns. Three or more coded patterns may be used for distance measurement.

Types of the coded patterns can vary according to types of an object and a measurement environment. The coded pattern memory 56 may store a plurality of coded patterns or a plurality of coded pattern groups. A coded pattern or a coded pattern group is selected based on types of an object and a measurement environment.

The processor 54 causes the display device 52 to display a distance image indicative of a distance of each pixel. An example of the distance image is an image expressing each pixel in a color corresponding to a distance.

In addition to a displaying distance information, the processor 54 may use the distance information to perform various controls. For example, when the electronic device 62 is applied to a self-propelled robot, the processor 54 controls running of the robot to avoid objects, based on a distance to the objects.

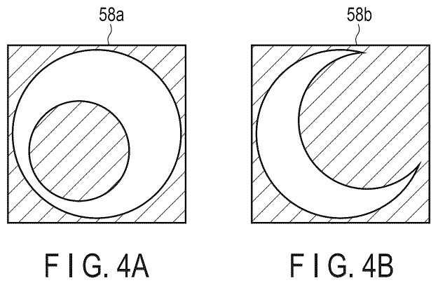

FIG. 4A and FIG. 4B are diagrams showing examples of the coded pattern used in the electronic device according to the first embodiment. The coded pattern memory 56 stores a coded pattern group including two coded patterns, first and second coded patterns different from each other. FIG. 4A shows an example of a first coded pattern 58a. FIG. 4B shows an example of a second coded pattern 58b. The coded patterns 58a and 58d are set such that the degree of blur varies according to the degree of deviation of an object from a focused state. Further, the coded patterns 58a and 58b are set such that shapes of blur are different between a case where an object is in front of a focus position and a case where the object is behind the focus position. That is, the coded patterns 58a and 58b need to have shapes other than point symmetrical shapes.

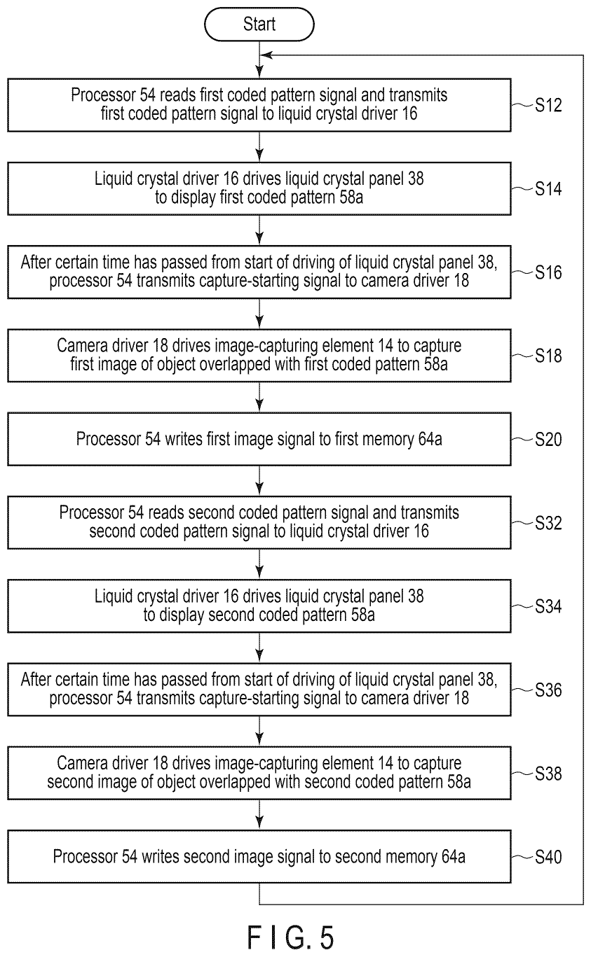

FIG. 5 is a flowchart showing an example of a camera control by the electronic device 62 according to the first embodiment. The processor 54 starts processes shown in FIG. 5 on receiving an instruction signal for distance measurement. An example of the instruction signal includes a signal that is generated while a shutter button of the camera 60 is pressed.

On receiving instruction signal, the processor 54 reads a first coded pattern signal from the coded pattern memory 56 and then transmits the first coded pattern signal to the liquid crystal driver 16 via the camera driver 18 (S12).

The liquid crystal driver 16 drives the liquid crystal panel 38 according to the first coded pattern signal to display the first coded pattern 58a (S14).

A displayed image on the liquid crystal panel 38 does not change immediately after the start of driving. The displayed image starts changing after display transition time has passed. Display transition time depends on display patterns. The longest display transition time is predictable. The liquid crystal panel 38 displays the first coded pattern 58a after a certain time has passed after the start of driving by the first coded pattern signal. The certain time is set to be longer than the longest display transition time. During the certain time, a displayed image on the liquid crystal panel 38 gradually changes from a previously-displayed image to the first coded pattern 58a.

After the certain time has passed from the start of driving of the liquid crystal panel 38 by the first coded pattern signal, the processor 54 transmits a capture-starting signal to the camera driver 18 (S16).

On receiving the capture-starting signal, the camera driver 18 drives the image-capturing element 14 to capture a first image of an object overlapped with the first coded pattern 58a (S18). A first image signal captured by the image-capturing element 14 is transmitted to the processor 54 via the camera driver 18.

The processor 54 writes the first image signal transmitted from the camera 60 to the first memory 64a (S20).

The processor 54 reads a second coded pattern signal from the coded pattern memory 56 and then transmits the second coded pattern signal to the liquid crystal driver 16 via the camera driver 18 (S32).

The liquid crystal driver 16 drives the liquid crystal panel 38 according to the second coded pattern signal to display the second coded pattern 58b (S34).

After the certain time has passed from the start of driving of the liquid crystal panel 38 by the second coded pattern signal, the processor 54 transmits the capture-starting signal to the camera driver 18.

On receiving the capture-starting signal, the camera driver 18 drives the image-capturing element 14 to capture a second image of an object overlapped with the second coded pattern 58b (S38). A second image signal captured by the image-capturing element 14 is transmitted to the processor 54 via the camera driver 18.

The processor 54 writes the second image signal transmitted from the camera 60 to the second memory 64b (S40).

Then, the processor 54 reads the first coded pattern signal from the coded pattern memory 56 and performs the process of transmitting the first coded pattern signal to the liquid crystal driver 16 via the camera driver 18 again (S12).

The processor 54 repeats the processes shown in FIG. 5 until the reception of a capture-end signal.

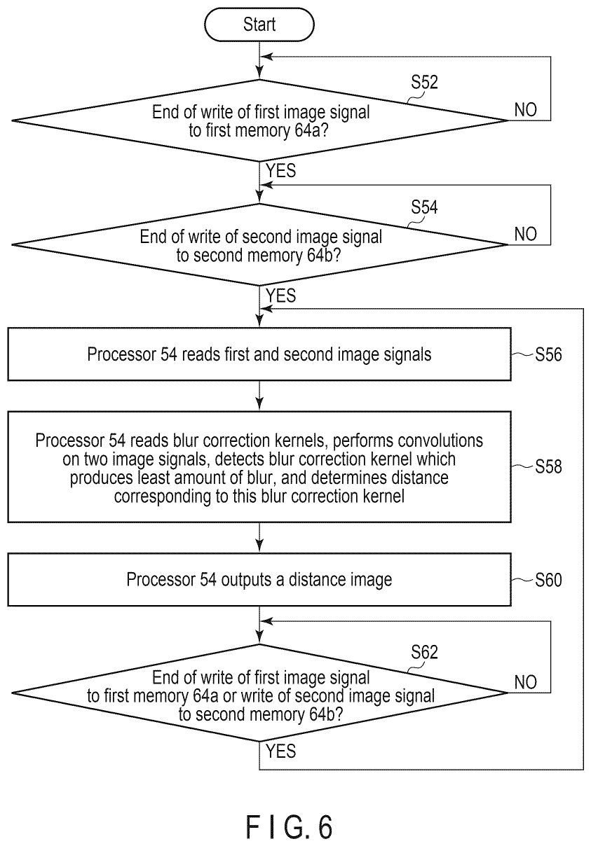

FIG. 6 is a flowchart showing an example of a distance measurement by the electronic device 62 according to the first embodiment. The processor 54 performs processes shown in FIG. 6 during receiving instruction signal for distance measurement.

The processor 54 determines whether a write of the first image signal overlapped with the first coded pattern 58a to the first memory 64a ends (S52). The processor 54 repeats the determination process (S52) until the write of the first image signal to the first memory 64a ends.

When the processor 54 determines that the write of the first image signal to the first memory 64a ends (YES in S52), the processor 54 then determines whether a write of the second image signal overlapped with the second coded pattern 58b to the second memory 64b ends (S54). The processor 54 repeats the determination process (S54) until the write of the second image signal to the second memory 64b ends.

When the processor 54 determines that the write of the second image signal to the second memory 64b ends (YES in S54), the processor 54 reads the first image signal from the first memory 64a and reads the second image signal from the second memory 64b (S56).

The processor 54 sequentially reads many blur correction kernels from the correction kernel memory 66, sequentially performs convolutions on each pixel of the two image signals using many blur correction kernels, detects the blur correction kernel which produces the calculation result including the least amount of blur for pixels, and uses the distance corresponding to this blur correction kernel as the measurement result for the distance from the camera 60 to the object (S58).

The processor 54 outputs a distance image (S60). An example of outputting is expressing each pixel in a color corresponding to its distance and displaying a distance image using the display device 52.

The processor 54 determines whether the write of the first image signal overlapped with the first coded pattern 58a to the first memory 64a or the write of the second image signal overlapped with the second coded pattern 58b to the second memory 64b ends (S62). The processor 54 repeats the determination process (S62) until the write of the first image signal to the first memory 64a or the second image signal to the second memory 64b ends.

When the processor 54 determines that the write of the first image signal to the first memory 64a or the second image signal to the second memory 64b ends, the processor 54 performs the process in S56 (reading the first image signal from the first memory 64a and reading the second image signal from the second memory 64b) again.

The processor 54 repeats the processes shown in FIG. 6 until reception of instruction signal ends.

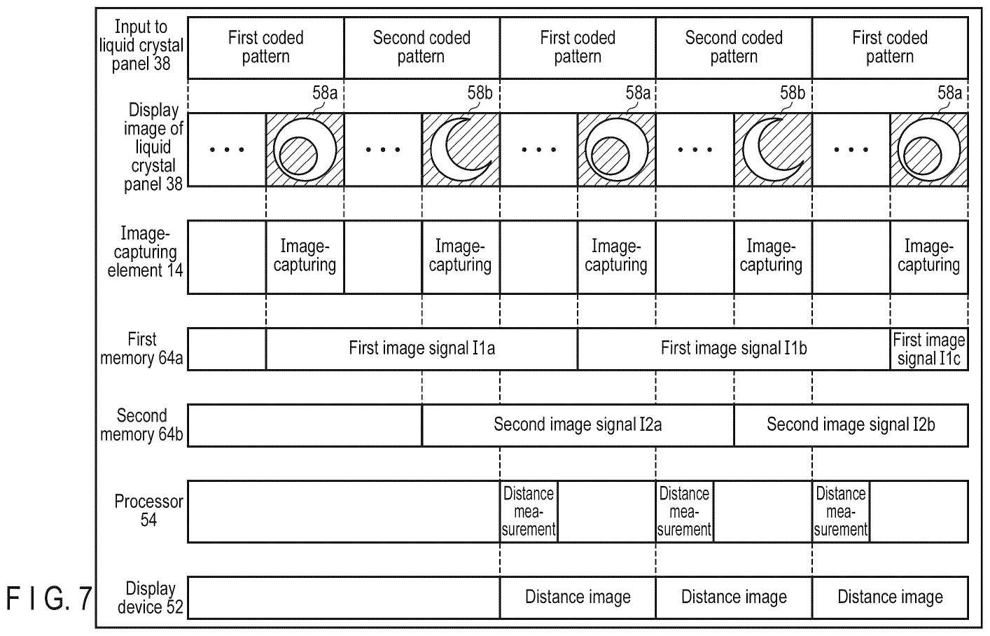

FIG. 7 is a sequence chart showing an example of a flow of processes executed by the electronic device 62 according to the first embodiment. A horizontal axis in FIG. 7 indicates time.

The processor 54 periodically and alternately supplies the liquid crystal panel 38 with the first coded pattern signal and the second coded pattern signal. In the odd-numbered cycles, the liquid crystal panel 38 is supplied with the first coded pattern signal. In the even-numbered cycles, the liquid crystal panel 38 is supplied with the second coded pattern signal. The display state of the liquid crystal panel 38 does not change immediately after supplied coded pattern signal have been switched. A displayed image on the liquid crystal panel 38 changes gradually after input of the first coded pattern signal. After the certain time has passed, this displayed image changes to the first coded pattern 58a. Similarly, a displayed image on the liquid crystal panel 38 changes gradually after input of the second coded pattern signal. After the certain time has passed, this displayed image changes to the second coded pattern 58b.

In the odd-numbered cycles, a displayed image on the liquid crystal panel 38 changes to the first coded pattern 58a, and then the image-capturing element 14 captures an image of an object overlapped with the first coded pattern 58a and outputs the first image signal. In the even-numbered cycles, a displayed image on the liquid crystal panel 38 changes to the second coded pattern 58b, and then the image-capturing element 14 captures an image of an object overlapped with the second coded pattern 58b and outputs the second image signal.

In the odd-numbered cycle, a first image signal I1a is written to the first memory 64a. The first memory 64a stores the first image signal I1a until a next first image signal I1b is written to the first memory 64a in the next odd-numbered cycle. In the even-numbered cycle, a second image signal I2a is written to the second memory 64b. The second memory 64b stores the second image signal I2a until a next second image signal I2b is written to the second image memory 64b in the next even-numbered cycle.

In each cycle, the first image signal I1 or the second image signal I2 is updated. Thus, in each cycle, a pair of the first image signal I1 and the second image signal I2 is updated. In each cycle, the processor 54 measures a distance using the latest pair of the first image signal I1 and the second image signal I2. In this manner, a distance is measured in each cycle. Thus, a distance can be measured in the rate same as the capturing rate of videos, and a distance image can be output.

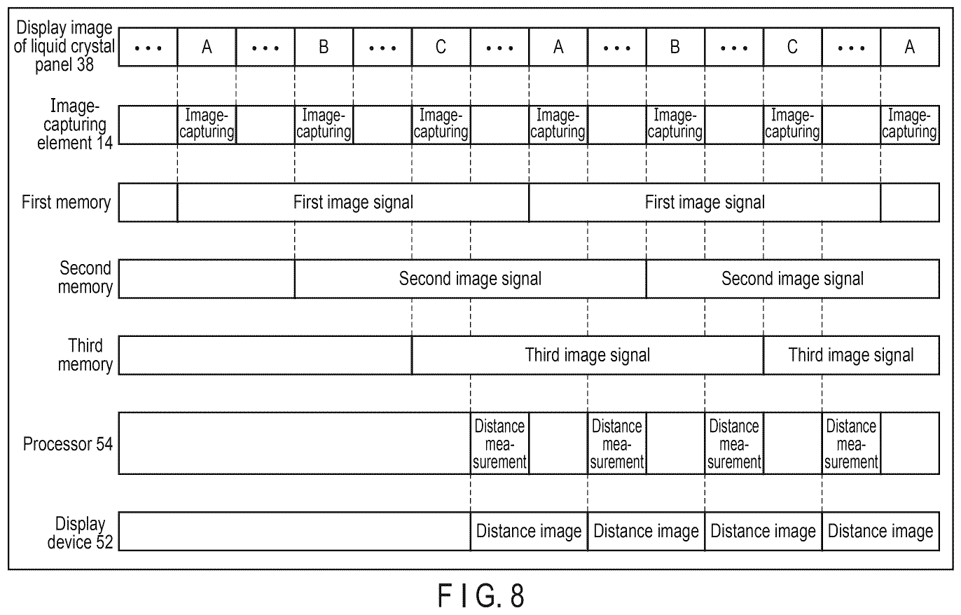

FIG. 8 is a sequence chart showing another example of a flow of processes executed by the electronic device 62 according to the first embodiment. FIG. 8 shows an example using three different coded patterns A, B, and C for distance measurement. In this example as well, a first image signal of an object overlapped with the coded pattern A, a second image signal of an object overlapped with the coded pattern B, or a third image signal of an object overlapped with the coded pattern C is updated in each cycle. Thus, a set of the first image signal, the second image signal, and third image signal is updated in each cycle. In each cycle, the processor 54 measures a distance using the latest set of the first image signal, the second image signal, and the third image signal.

In the first embodiment, distance measurement is performed in each cycle. Thus, distance measurement with the rate same as the capturing rate of videos can be achieved.

### Second Embodiment

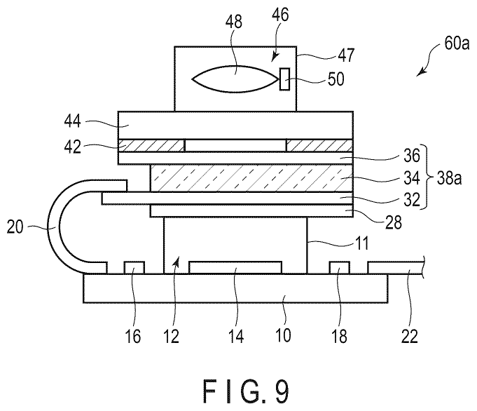

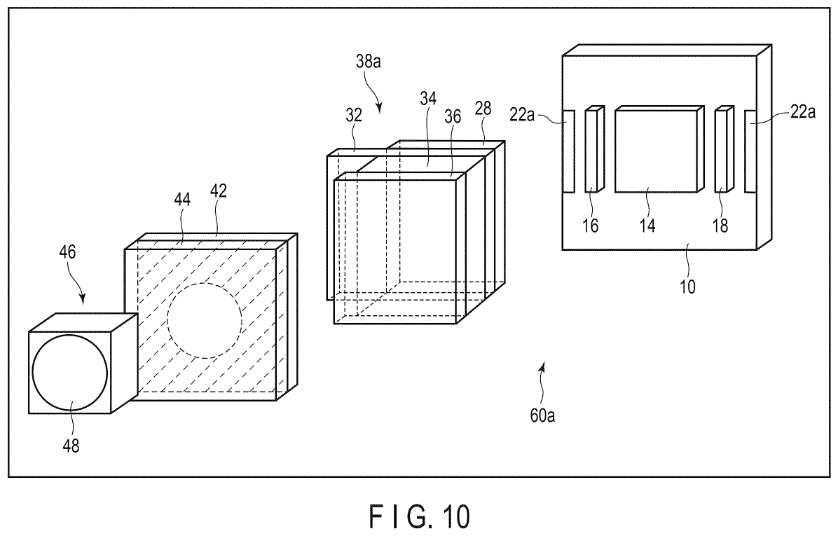

FIG. 9 is a side view showing an example of a structure of a camera 60a according to the second embodiment. FIG. 10 is an exploded perspective view showing an example of the camera 60a according to the second embodiment.

The camera 60a includes a liquid crystal panel 38a instead of the liquid crystal panel 38 according to the first embodiment. The liquid crystal panel 38a includes the array substrate 32, the liquid crystal layer 34, and the counter-substrate 36. The liquid crystal panel 38a has a different arrangement order of the array substrate 32, the liquid crystal layer 34, and the counter-substrate 36 from that of the liquid crystal panel 38. In the liquid crystal panel 38a, the array substrate 32 is provided below the liquid crystal layer 34. The counter substrate 36 is provided on the liquid crystal layer 34.

The flexible printed film 20 is connected to the surface of the array substrate 32 facing the liquid crystal layer 34. The array substrate 32 requires a contact area for the flexible printed film 20. Thus, the array substrate 32 is greater in size than the counter-substrate 36.

The flexible printed film 20 may be connected to a surface of the array substrate 32 facing the IR filter 28.

Further, the flexible printed film 20 may be connected to a surface of the counter-substrate 36 facing the liquid crystal layer 34. In this case, the counter-substrate 36 requires a contact area for the flexible printed film 20. Thus, the counter-substrate 36 is greater in size than the array substrate 32.

### Third Embodiment

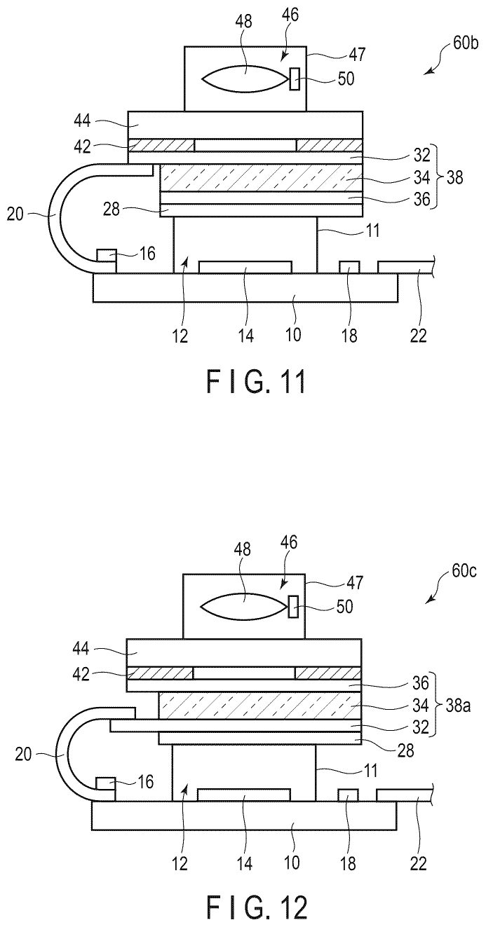

FIG. 11 is a side view showing an example of a structure of a camera 60b according to the third embodiment.

The third embodiment relates to a modified example of the first embodiment. The camera 60b is different from the camera 60 in a point that the liquid crystal driver 16 is provided on not the camera substrate 10 but the flexible printed film 20. Thus, the third embodiment achieves the effects similar to those of the first embodiment. Further, the camera substrate 10 in the third embodiment does not need space for the liquid crystal driver 16. Thus, the camera substrate 10 in the third embodiment is small in its plane size. In addition to the liquid crystal driver 16, the camera driver 18 may also be provided on the flexible printed film 22.

### Fourth Embodiment

FIG. 12 is a side view showing an example of a structure of a camera 60c according to the fourth embodiment.

The fourth embodiment relates to a modified example of the second embodiment. The camera 60c is different from the camera 60a in a point that the liquid crystal driver 16 is provided on not the camera substrate 10 but the flexible printed film 20. Thus, the fourth embodiment achieves the effects similar to those of the second embodiment. Further, the camera substrate 10 in the fourth embodiment does not need space for the liquid crystal driver 16. Thus, the camera substrate 10 in the fourth embodiment is small in its plane size. In addition to the liquid crystal driver 16, the camera driver 18 may also be provided on the flexible printed film 22.

### Fifth Embodiment

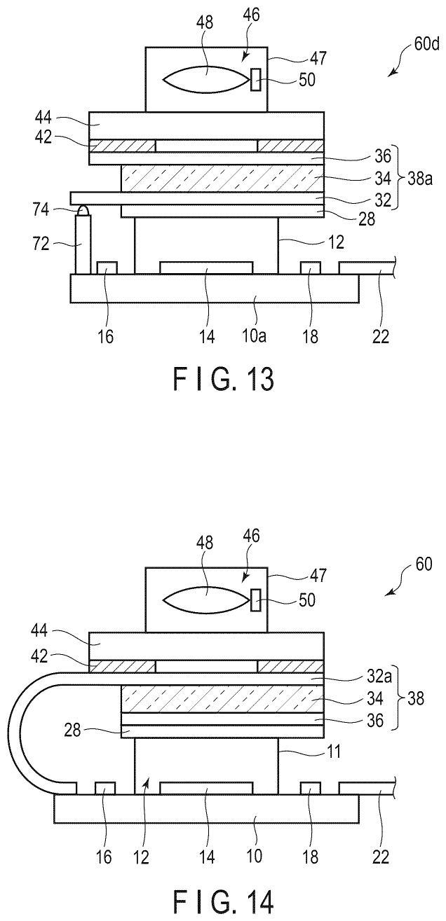

FIG. 13 is a side view showing an example of a structure of a camera 60d according to the fifth embodiment.

The fifth embodiment relates to a modified example of the second embodiment. The camera 60d is different from the camera 60a in using not the flexible printed film 20 but a solder ball 74 as a portion for connecting the liquid crystal driver 16 with the liquid crystal panel 38a. The solder ball 74 is provided on each of support portions 72 arranged in a two dimensional-array shape on a camera substrate 10a around the camera module 12. The support portion 72 has an internal signal line. The solder balls 74 are electrically connected to the camera substrate 10 via the support portions 72. The camera substrate 10a is called a Ball Grid Array (BGA) substrate as well.

In the first to fourth embodiments, the flexible printed film 20 electrically connecting the camera substrate 10 with the array substrate 32 is curved from the camera substrate 10 and the array substrate 32 toward their surroundings. Thus, the average size of the cameras 60, 60a, 60b, and 60c is slightly greater than the camera substrate 10. In the fifth embodiment, the solder balls 74 electrically connecting the camera substrate 10a with the array substrate 32 are provided immediately below the array substrate 32. This configuration prevents the plane size of the camera 60d from becoming greater than that of the camera substrate 10a.

### Sixth Embodiment

FIG. 14 is a diagram showing an example of a cross-sectional structure of the camera 60 according to the sixth embodiment.

In the six embodiment, the array substrate 32 according to the first embodiment to the fifth embodiment is replaced with the array substrate 32a formed of a flexible printed film. An end of the array substrate 32a is electrically connected to the camera substrate 10.

According to the sixth embodiment, the array substrate 32a and the flexible printed film are integrally configured. Thus, the sixth embodiment does not need a contact area for the array substrate 32a and the flexible printed film. Therefore, a plane size of the liquid crystal panel 38 is smaller than that in the first embodiment to the fifth embodiment. Further, a process for connecting the array substrate 32a with the flexible printed film is unnecessary. Further, this configuration prevents the connection between the array substrate 32a and the flexible printed film from becoming unstable.

In the sixth embodiment, similarly to the third embodiment, the liquid crystal driver 16 may be provided on the array substrate 32a.

In the sixth embodiment, similarly to the modified example of the first embodiment, not the array substrate 32 but the counter-substrate 36 may be formed of a flexible printed film.

### Seventh Embodiment

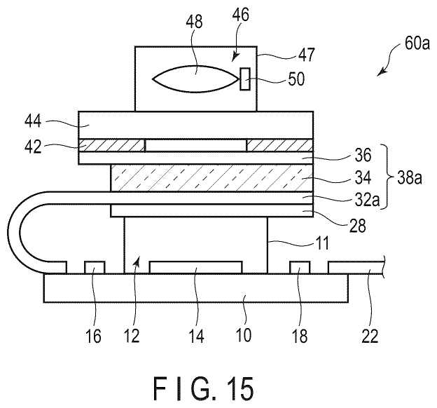

FIG. 15 is a diagram showing an example of a cross-sectional structure of the camera 60 according to the seventh embodiment.

In the seventh embodiment, the array substrate 32 of the second embodiment is replaced with the array substrate 32a formed of a flexible printed film. An end of the array substrate 32a is electrically connected to the camera substrate 10.

The seventh embodiment does not need a contact area for the array substrate 32a and the flexible printed film. Therefore, a plane size of the liquid crystal panel 38a is smaller than that in the first embodiment. Further, a process for connecting the array substrate 32a with the flexible printed film is unnecessary. Further, this configuration prevents the connection between the array substrate 32a and the flexible printed film from becoming unstable.

In the seventh embodiment, similarly to the fourth embodiment, the liquid crystal driver 16 may be provided on the array substrate 32a formed of a flexible printed film.

According to the seventh embodiment, similarly to the modified example of the second embodiment, not the array substrate 32a but the counter-substrate 36 may be formed of the flexible printed film.

In the above embodiments, the liquid crystal panel 38 is provided on the front surface (the capturing surface of the image-capturing element 14) of the camera module 12. The lens module 46 is provided on the front surface of the liquid crystal panel 38. Light passed through the lens module 46 is made incident on the image-capturing element 14 via the liquid crystal panel 38. The arrangement order of the lens module 46 and the liquid crystal panel 38 may be reversed. That is, the lens module 46 may be provided on the front surface of the camera module 12. The liquid crystal panel 38 may be provided on the front surface of the lens module 46. Light passed through the liquid crystal panel 38 may be made incident on the image-capturing element 14 via the lens module 46.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a liquid crystal panel;
an image-capturing element configured to capture an image of an object via the liquid crystal panel; and
a processor configured to control the liquid crystal panel and the image-capturing element, wherein the processor is configured to:
cause the liquid crystal panel to alternately display a first pattern and a second pattern;
cause the image-capturing element to alternately capture a first image of an object overlapped with the first pattern and a second image of the object overlapped with the second pattern;
after the second image being captured, measure a distance of the object based on the second image and the first image captured prior to the second image; and
after the first image being captured, measure a distance of the object based on the first image and the second image captured prior to the first image.

2. The electronic device of claim 1, wherein
the first pattern and the second pattern are not point symmetrical.

3. The electronic device of claim 1, wherein
the first image of the object overlapped with the first pattern and the second image of the object overlapped with the second pattern are blurred; and
a degree of blur of the first image and a degree of blur of the second image depend on a degree of deviation of the object from a focused state.

4. The electronic device of claim 1, wherein
the first image of the object overlapped with the first pattern and the second image of the object overlapped with the second pattern are blurred; and
a shape of blur of the first image and a shape of blur of the second image depend on whether the object is in front of or behind a focus position.

5. An electronic device comprising:
a liquid crystal panel;
an image-capturing element configured to capture an image of an object via the liquid crystal panel; and
a processor configured to control the liquid crystal panel and the image-capturing element, wherein the processor is configured to:
cause the liquid crystal panel to periodically display a first pattern, a second pattern, and a third pattern;
cause the image-capturing element to periodically capture a first image of an object overlapped with the first pattern, a second image of the object overlapped with the second pattern, and a third image of the object overlapped with the third pattern;
after the third image being captured, measure a distance of the object based on the third image, the first image captured prior to the third image, and the second image captured prior to the third image;
after the first image being captured, measure a distance of the object based on the first image, the third image captured prior to the first image, and the second image captured prior to the first image; and
after the second image being captured, measure a distance of the object based on the second image, the first image captured prior to the third image, and the third image captured prior to the third image.

6. An electronic device comprising:
a liquid crystal panel;
an image-capturing element configured to capture an image of an object via the liquid crystal panel; and
a processor configured to control the liquid crystal panel and the image-capturing element, wherein the processor is configured to:
cause the liquid crystal panel to periodically display patterns;
cause the image-capturing element to periodically capture images of an object overlapped with the patterns, respectively;
after each of the images being captured, measure a distance of the object based on the each of the images and images captured prior to the each of the images.
